(19) United States
(12) Patent Application Publication
(10) Pub. No.: US 2024/0110567 A1
(43) Pub. Date: Apr. 4, 2024

(54) MEASUREMENT ASSEMBLIES AND METHODS FOR MEASURING NOSE GAP IN PUMPS

(71) Applicant: GIW Industries, Inc., Grovetown, GA (US)

(72) Inventors: James A. Baker, Edmonton (CA); Viktor Leontyev, Edmonton (CA)

(21) Appl. No.: 18/371,725

(22) Filed: Sep. 22, 2023

Related U.S. Application Data
(60) Provisional application No. 63/411,368, filed on Sep. 29, 2022.

(51) Int. Cl. F04D 7/04; F04D 15/00; F04D 29/42; G01S 7/521; G01S 7/53; G01S 15/10

(52) U.S. Cl. CPC F04D 7/04; F04D 15/0027; F04D 29/4286; G01S 7/521; G01S 7/53; G01S 15/101; G01S 15/102

(57) ABSTRACT

Assemblies and methods for measuring the nose gap of a centrifugal pump may include using an ultrasonic transducer coupled to a suction liner of the centrifugal pump to measure the nose gap of a slurry pump for pumping a slurry mixture, which can include sand, rock, and other particulates. A signal analyzer may be used to determine the size of the nose gap based on scatterings and reflections of an ultrasonic pulse passing into or through the adjustable liner, through the medium being pumped, and reflected from the impeller. The assemblies and methods may provide an ability to obtain a real-time measurement of the nose gap during operation of the centrifugal pump, which may result in an ability to adjust nose gap to provide more efficient operation of the pump and reduced wear rates.

### CROSS REFERENCE TO RELATED APPLICATION

The present application claims the benefit of previously filed, co-pending U.S. Provisional Patent Application No. 63/411,368, filed Sep. 29, 2022.

### INCORPORATION BY REFERENCE

The specification and drawings of U.S. Provisional Patent Application No. 63/411,368, filed Sep. 29, 2022, are specifically incorporated herein by reference as if set forth in their entirety.

### TECHNICAL FIELD

The present disclosure relates to assemblies and methods for measuring a nose gap in pumps and, more particularly, to assemblies and methods for measuring the nose gap of centrifugal pumps such as slurry pumps. Other aspects also are described.

### BACKGROUND

A centrifugal pump may include an impeller for pumping a pumped medium, such as a liquid or a liquid containing solid or semi-solid particulates, such as a slurry. The impeller may be contained within a chamber at least partially formed by a housing or casing, and rotates within that chamber in order to add kinetic energy to the fluid, which is then converted to pressure energy by the diffusing effect of the housing or casing. Thus, a pressure differential exists within the pump, with a higher pressure in the casing downstream of the impeller outlet, and lower pressure at the impeller inlet. The impeller may include a surface that faces outward toward an interior face of the housing or casing in which the impeller rotates, and at which a small clearance gap (sometimes referred to as a “nose gap”) exists in order to prevent rubbing of the rotating impeller against the stationary housing or casing. A pressure differential exists across this gap due to the pressure differential from impeller outlet to inlet, and this drives a flow of the pumped fluid through the gap. This flow results in a loss of energy within the pump by allowing pressure energy to leak from the high pressure side of the pump back to the low pressure side, resulting in a reduction in overall pump efficiency. Very small increases in the width of this gap (for example a few millimeters) may result in a loss of efficiency of several percentage points. Since centrifugal pumps are very common machines and may consume large amounts of energy, it is desirable to minimize the width of this gap as much as possible. In a centrifugal slurry pump, the flow through the gap may carry abrasive particles at high velocity, resulting in accelerated erosive wear at the surfaces comprising the gap. The wear results in a widening of the gap with resulting loss in efficiency, as described above. The wider gap allows ever more flow and therefore also further accelerates the rate of wear, such that this particular area of the centrifugal slurry pump is often the most high wearing area within the pump, and the wear rate in this area often determines the service life of the pump. By controlling the gap over time, the pump efficiency can be maintained at a higher level and the mean time between maintenance increased, resulting in significant savings in power, labor and cost of parts replacement.

Attempts to control the size of the nose gap include providing a suction liner between the housing or casing of the pump and the impeller. The suction liner may be constructed of wear resistant materials, but will still wear with use of the pump and, in some instances, be adjusted to maintain a minimum nose gap as the surfaces of the suction liner and impeller at the gap wear. For example, as the suction liner wears and its thickness becomes reduced, the suction liner may be moved toward the impeller to thereby reduce the nose gap that has increased due to the wear of the suction liner. Although the adjustable suction liner may be used to reduce the nose gap as the suction liner wears, it may be difficult to move the suction liner to a position that results in a minimum nose gap, for example, because it is difficult to determine how far to move the suction liner without stopping and possibly also partially disassembling the pump, which results in down time, lost production and increased labor. As one alternative, adjustment of the suction liner may be performed according to a schedule based on, for example, the run-time and/or medium pumped by the pump. This inexact approach usually results in very conservative adjustment, in order to avoid the possibility of over-adjustment, which may lead to rubbing of the rotating impeller against the stationary liner and subsequent catastrophic failure due to heat generation between the parts. Such conservative adjustment strategies provide some benefit, relative to no adjustment, but fall far short of the potential savings in power, labor and parts usage, which more accurate adjustment can provide. Another alternative is to move the suction liner slowly toward the impeller while the pump is running and while an experienced technician listens for contact between the suction liner and the impeller, sometimes using a stethoscope. Once contact between the suction liner and the impeller is detected, the suction liner may be moved slightly away from the impeller to set the nose gap at the minimum value possible without rubbing, thus optimizing pump efficiency, minimizing wear rate at the gap and maximizing the service life of the suction liner. This process, however, is also inexact, since identification of the sound of rubbing within the pump is difficult to distinguish from the background noise of the fluid flow, the solids moving through the pump, and the general background noise of surrounding machinery. Errors of judgement in identifying the point of rubbing may result in unintentional and significant damage to the pump, for example, if the suction liner is tightened against the impeller during operation of the pump. Such failure represents a sudden, unplanned stoppage of the pump, which may result in significant economic loss in equipment damage, and lost production due to down time, and labor expense due the need to drain and at least partially disassemble and inspect or repair the pump. As a result, many pumping sites either avoid adjusting the suction liner or adjust it very conservatively, resulting in large nose gaps that reduce the efficiency and service life of the pump and increase the costs of labor and parts usage.

Accordingly, it can be seen that a need exists for providing assemblies and methods to measure the nose gap and/or adjust suction liners more efficiently that may address the foregoing and other related, and unrelated, issues, and/or problems.

### SUMMARY

In view of the foregoing, in one aspect, the present disclosure is directed to assemblies and methods for measuring the nose gap of a centrifugal pump, such as a slurry pump. The methods and assemblies may include using an ultrasonic transducer coupled to a suction liner of the centrifugal pump to measure the nose gap, for example, during operation of a slurry pump for pumping a slurry mixture, which can include sand, rock and other particulates. In some embodiments, a signal analyzer may be used to determine the size of the nose gap based on scatterings and/or reflections of an ultrasonic pulse passing into and/or through the adjustable liner, through the medium being pumped, and reflected from the impeller. In some embodiments, the assemblies and methods may provide an ability to obtain a real-time measurement of the nose gap during operation of the centrifugal pump, which may result in an ability to adjust nose gap to provide more efficient operation of the pump and/or reduced wear rates.

In some embodiments, a measurement assembly for measuring the nose gap of a centrifugal pump, such as a slurry pump, according to the present disclosure, will include at least one ultrasonic transducer configured to be coupled to a suction liner of a slurry pump, and a driver circuit electrically connected to the at least one ultrasonic transducer and configured to cause the at least one ultrasonic transducer to emit an ultrasonic pulse into the suction liner, through a medium in the nose gap, and against an impeller of the centrifugal pump. The assembly also includes a signal analyzer in communication with the at least one ultrasonic transducer and configured to receive a first pulse return signal associated with an interface between the suction liner and the medium, a second pulse return signal associated with a surface of the impeller, and one or more pulse reflection signals associated with reflections of the ultrasonic pulse between the suction liner and the impeller. The signal analyzer also is configured to determine a size of the nose gap based at least in part on one or more of the first pulse return signal, the second pulse return signal, or the one or more pulse reflection signals.

According to still another aspect, the present disclosure is also generally directed to a method for measuring a distance between a suction liner and an impeller of a slurry pump, including causing at least one ultrasonic transducer to emit an ultrasonic pulse into the suction liner of the slurry pump, through a medium between the suction liner and the impeller of the slurry pump, and against the impeller of the slurry pump. The method also can include receiving, via a signal analyzer in communication with the at least one ultrasonic transducer, a first pulse return signal associated with an interface between the suction liner and the medium, a second pulse return signal associated with a surface of the impeller, and one or more pulse reflection signals associated with reflections of the ultrasonic pulse between the suction liner and the impeller. In some embodiments, the method also includes determining the distance between the suction liner and the impeller based at least in part on one or more of the first pulse return signal, the second pulse return signal, or the one or more pulse reflection signals.

In still another aspect, the present disclosure is also directed to a method for adjusting a distance between a suction liner and an impeller of a centrifugal pump, such as a slurry pump, including causing at least one ultrasonic transducer to emit an ultrasonic pulse into the suction liner of the slurry pump, through a medium between the suction liner and the impeller of the slurry pump, and against the impeller of the slurry pump. The method also can include receiving, via a signal analyzer in communication with the at least one ultrasonic transducer, a first pulse return signal associated with an interface between the suction liner and the medium, a second pulse return signal associated with a surface of the impeller, and one or more pulse reflection signals associated with reflections of the ultrasonic pulse between the suction liner and the impeller. The method also can include determining the distance between the suction liner and the impeller based at least in part on one or more of the first pulse return signal, the second pulse return signal, or the one or more pulse reflection signals. The method further can include causing, based at least in part on the distance between the suction liner and the impeller, the suction liner to move axially in a direction substantially parallel to a shaft axis of a pump shaft coupled to the impeller.

In yet another aspect, the present disclosure may be directed to a centrifugal pump assembly including a casing defining a substantially annular interior chamber, a first plate coupled to the casing and defining a first bore, and a second plate coupled to the casing opposite the first plate and defining an inlet bore configured to receive a medium being pumped. The centrifugal pump assembly also can include a pump shaft having a shaft axis, with the pump shaft being received through the first bore and being configured to rotate about the shaft axis. The centrifugal pump further can include an impeller received in the substantially annular interior chamber and coupled to the pump shaft, with the impeller defining an impeller face facing toward an interior side of the second plate. The centrifugal pump assembly still further can include a suction liner movably coupled to the second plate and defining a liner wear surface positioned adjacent the impeller face of the impeller, such that the liner wear surface and the impeller face at least partially define a nose gap therebetween.

In some embodiments, the centrifugal pump assembly also can include a measurement assembly for measuring the nose gap, including at least one ultrasonic transducer configured to be coupled to the suction liner, and a driver circuit electrically connected to the at least one ultrasonic transducer and configured to cause the at least one ultrasonic transducer to emit an ultrasonic sound wave into the suction liner, through a medium in the nose gap, and against the impeller face. The measurement assembly also can include a signal analyzer in communication with the at least one ultrasonic transducer and configured to receive a first pulse return signal associated with an interface between the suction liner and the medium, a second pulse return signal associated with the impeller face, and one or more pulse reflection signals associated with reflections of the ultrasonic pulse between the suction liner and the impeller, and determine a size of the nose gap based at least in part on one or more of the first pulse return signal, the second pulse return signal, or the one or more pulse reflection signals.

These and other advantages and aspects of the embodiments of the disclosure will become apparent and more readily appreciated from the following detailed description of the embodiments and the claims, taken in conjunction with the accompanying drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced.

FIG. 1 is a perspective view of an example embodiment of a centrifugal pump assembly according to an aspect of the present disclosure.

FIG. 2A is a partial side section view of an example embodiment of a centrifugal pump including an example embodiment of a suction liner in a first position according to an aspect of the present disclosure.

FIG. 2B is a partial side section view of the centrifugal pump shown in FIG. 2A with the suction liner in a second position according to an aspect of the present disclosure.

FIG. 2C is a partial side section view of the centrifugal pump shown in FIGS. 2A and 2B providing a detailed view of an example nose gap according to an aspect of the present disclosure.

FIG. 3 is a partial perspective section view of an example embodiment of a centrifugal pump including an example embodiment of an adjustable suction liner and example embodiments of adjustment bolts for adjusting the axial position of the suction liner according to an aspect of the present disclosure.

FIG. 4 is a partial side section view of an example embodiment of a centrifugal pump including an example embodiment of an adjustable suction liner and example embodiments of adjustment bolts for adjusting the axial position of the suction liner according to an aspect of the present disclosure.

FIG. 5A is a partial side section view of an example embodiment of a centrifugal pump including an example embodiment of an adjustable suction liner and adjustment bolts in a first position according to an aspect of the present disclosure.

FIG. 5B is a partial side section view of the centrifugal pump shown in FIG. 5A including with the adjustable suction liner and an adjustment bolt in a second position according to an aspect of the present disclosure.

FIG. 6 is a schematic partial side section view of an example embodiment of measurement assembly for measuring the nose gap of an example embodiment of a centrifugal pump according to an aspect of the present disclosure.

FIG. 7 is a schematic partial side section view of an example embodiment of measurement assembly schematically depicting a travel path of an example ultrasonic pulse signal and example pulse return signals according to an aspect of the present disclosure.

FIG. 8 is a flow diagram showing an example embodiment of a measurement assembly for measuring the nose gap and schematically depicting an ultrasonic pulse travelling through a suction liner to an impeller and pulse return signals according to an aspect of the present disclosure.

FIG. 9 is a flow diagram showing an example embodiment of a measurement assembly for measuring the nose gap and schematically depicting an ultrasonic pulse travelling through a suction liner to an impeller and pulse return signals being detected by a signal analyzer according to an aspect of the present disclosure.

FIG. 10 is a graph showing pulse return signal magnitude versus time for an example embodiment of a measurement assembly for measuring the nose gap of a centrifugal pump according to an aspect of the present disclosure.

FIG. 11 is a schematic diagram of an example embodiment of a suction liner and an example embodiment of a measurement assembly for measuring the nose gap of a centrifugal pump according to an aspect of the present disclosure.

FIG. 12A is a block diagram of an example method for measuring a distance between a suction liner and an impeller of a centrifugal pump according to an aspect of the present disclosure.

FIG. 12B is a continuation of the block diagram shown in FIG. 12A according to an aspect of the present disclosure.

FIG. 13 is a schematic diagram of an example suction liner controller according to an aspect of the present disclosure.

### DETAILED DESCRIPTION

The following description is provided as an enabling teaching of embodiments of this disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the disclosure and not in limitation thereof, because the scope of the disclosure is defined by the claims.

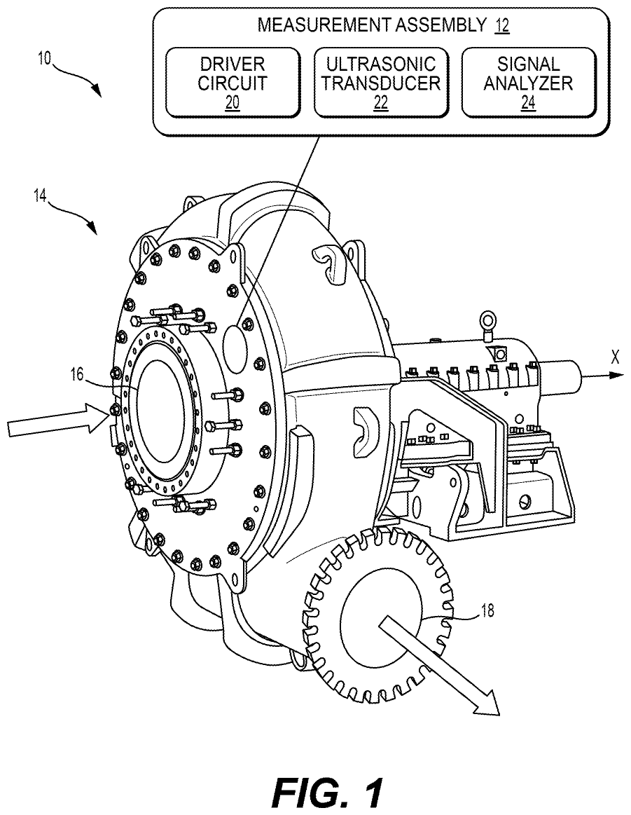

As generally shown in FIG. 1, the present disclosure is directed to a pump assembly 10 and a measurement assembly 12 for measuring a nose gap of a pump 14 of the pump assembly 12. As shown in FIG. 1, the pump 14 may be a slurry pump or other type of centrifugal pump for pumping a medium, such as a liquid and/or a slurry including a liquid and semi-solid and/or solid particulates. In the embodiment shown in FIG. 1, the liquid and/or slurry being pumped may be drawn into the pump 14 at an inlet 16 and pumped out an outlet 18 at a higher pressure, for example, as schematically depicted in FIG. 1. Although the example shown in FIG. 1 is a slurry pump, other types of pumps are contemplated.

As shown in FIG. 1, in some embodiments, the measurement assembly 12 may include one or more driver circuits 20 and one or more ultrasonic transducers 22 configured to emit ultrasonic pulses into one or more components of the pump 14. As shown in FIG. 1, the measurement assembly 12 further may include a signal analyzer 24 configured to receive pulse return signals resulting from scattering and/or reflection of the emitted ultrasonic pulses due to passage through, reflection from, and/or interfaces between one or more components of the pump 14 and/or the medium being pumped. Based at least in part on the pulse return signals, the signal analyzer 24 may be configured to determine one or more thicknesses associated with components of the pump 14 and/or thicknesses associated with spaces between components of the pump 14, such as a nose gap between a suction liner and an impeller of the pump 14, for example, as described herein. Although determining the thickness of the nose gap is used herein as an example of determinations that may be made, the assemblies and processes described herein may be used to determine additional and/or other dimensions and characteristics, such as, for example, characteristics related to the surface of the impeller (e.g., the thickness of the impeller, for example, at least partially or fully across the entire surface of the impeller). In some embodiments, the ultrasonic transducers 22 may include an ultrasonic transmitter configured to convert an electrical signal received from the driver circuits 20 into an emitted ultrasonic pulse and an ultrasonic receiver configured to receive and convert the ultrasonic pulse return signals into an electrical signal. In some embodiments, the ultrasonic transducers 22 may include an ultrasonic transceiver, which may act as both an ultrasonic transmitter and an ultrasonic receiver. In some embodiments, the driver circuits 20 and/or the signal analyzers 24 may be integrated with the ultrasonic transducers 22 into a single unified component. The ultrasonic transducer 22 may incorporate single element or dual element technology.

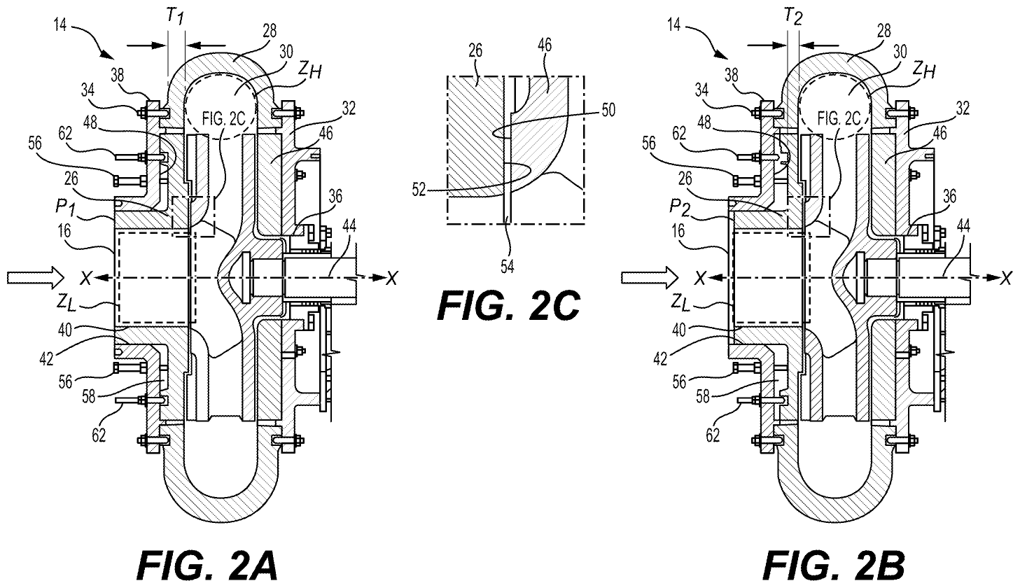

FIG. 2A is a partial side section view of an example embodiment of a pump 14 including an example embodiment of a suction liner 26 in a first axial position P₁, and FIG. 2B is a partial side section view of the pump 14 shown in FIG. 2A with the suction liner 26 in a second axial position P₂ according to an aspect of the present disclosure. As shown in FIG. 1, FIG. 2A, FIG. 2B, and FIG. 2C, the example pump 14 includes a casing 28 defining a substantially annular interior chamber 30, such as a volute. The pump 14 may also include a first plate 32 coupled to the casing 28 via a plurality of fasteners 34 (e.g., bolts). As shown in FIGS. 2A and 2B, the first plate 32 may define a first bore 36. The pump 14 further may include a second plate 38 coupled to the casing 28 opposite the first plate 32 via a plurality of fasteners 34 (e.g., bolts). Alternatively, a second plate 38 may be coupled to a first plate 32 directly by a plurality of fasteners 34, and a casing 28 clamped between the plates 32 and 38. The suction liner 26 may define a suction bore 40, and the second plate 38 may define an inlet bore 42. The suction bore 40 and the inlet bore 42 may be configured to receive a medium being pumped by the pump 14 at the inlet 16 of the pump 14. As shown in FIGS. 1-2B, the example pump 14 also may include a pump shaft 44 having a shaft axis X, and the pump shaft 44 is received through the first bore 36 in the first plate 32 and is configured to rotate about the shaft axis X as the pump 14 is operated. The example pump 14 also may include an impeller 46 received in the substantially annular interior chamber 30 and coupled to the pump shaft 44. Although not shown, a prime mover, such as an electric motor or internal combustion engine may be coupled to the pump shaft 44 to drive the pump shaft 44 and operate the pump 14.

As shown in FIGS. 2A and 2B, the second plate 38 may include an interior side 48, and the impeller 46 may define an impeller face 50 facing toward the interior side 48 of the second plate 38. In the example embodiment shown in FIGS. 2A and 2B, the suction liner 26 is movably coupled to the second plate 38 and defines a liner wear surface 52 positioned adjacent the impeller face 50 of the impeller 46, such that the liner wear surface 52 and the impeller face 50 at least partially define a nose gap 54 therebetween (FIG. 2C). As explained herein, as material of the liner wear surface 52 and impeller face 50 wear over time during operation of the pump 14, the thickness of the suction liner 36 adjacent the impeller face 50 is reduced, for example, as shown in FIGS. 2A and 2B, from a first thickness T₁ (FIG. 2A) to a second thickness T₂ (FIG. 2B), with the first thickness T₁ being greater than the second thickness T₂. In a similar way, the thickness of the impeller 46 is also reduced at the location of the impeller face 50.

For example, for a slurry pump such as the example pump 14 shown in FIGS. 1-2C, the pumping operation of the pump 14 during pumping of a medium M would be expected to be most efficient as the nose gap 54 of the pump 14 approaches zero, to the extent possible while still allowing the impeller 46 to rotate substantially freely relative to the liner wear surface 52 of the suction liner 26. In some embodiments, the size of the nose gap 54 may have a significant effect on the efficiency and wear life of the pump 14, for example, because the nose gap 54 provides a pathway for the medium M to flow around the impeller 46 and back through the inlet 16 of the pump 14. For example, as schematically depicted in FIG. 2A, during operation of the pump 14, as the impeller 46 rotates, it may generate a relatively higher pressure zone Z_{H} at an outer diameter of the impeller 46, and a pressure difference between the relatively high pressure zone Z_{H} and a relatively lower pressure zone Z_{L}, at the inlet 16 of the pump 14 and a central portion of the impeller 46 may draw the medium M through the nose gap 54, such that the medium M flows back toward the relatively low pressure zone Z_{L}. This recirculation of flow of the medium M may contribute to lower efficiency of operation of the pump 14, for example, because energy used to accelerate the medium M may be wasted. This recirculation also may contribute to increasing a rate of wear of the liner wear surface 52 and the impeller face 50, for example, because a larger nose gap 54 may permit relatively more particulates to flow past the impeller 46 at a higher velocity (e.g., when the medium M is a slurry), and this may result in the particulates eroding the liner wear surface 52 and/or the thickness material of the impeller face 50 on the suction side of the impeller 46 at a relatively higher wear rate.

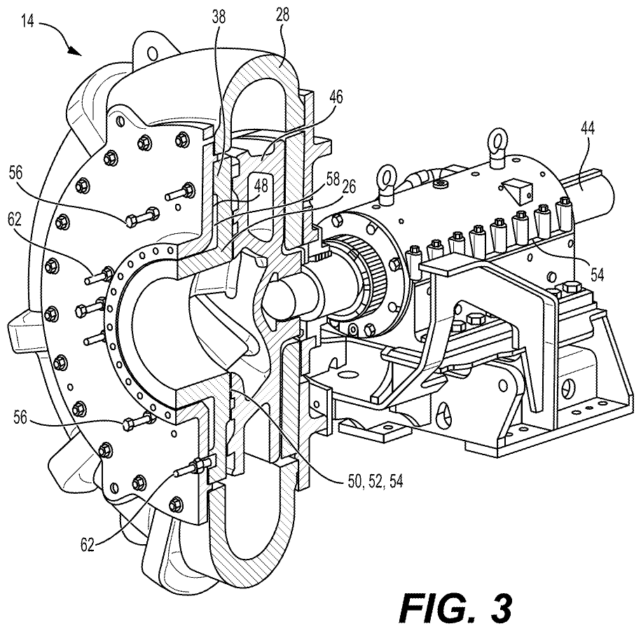

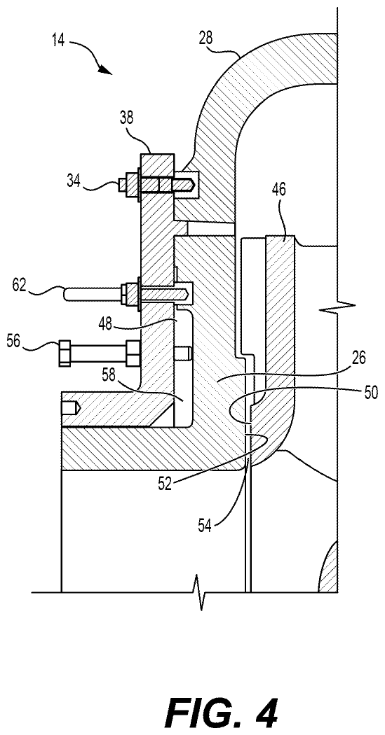

FIG. 3 is a partial perspective section view of an example embodiment of a pump 14 including an example embodiment of an adjustable suction liner 26 and example embodiments of adjustment bolts 56 for adjusting the axial position of the suction liner 26 according to an aspect of the present disclosure. FIG. 4 is a schematic partial side section view of an example embodiment of a pump 14 including adjustment bolts 56 for adjusting the axial position of the suction liner 26 according to an aspect of the present disclosure. As noted herein, in some embodiments, the suction liner 26 may be configured to be adjusted or moved axially in a direction substantially parallel to and/or colinear with the shaft axis X of the pump shaft 44, such that when, for example, the thickness of the liner wear surface 52 decreases with wear over time with use of the pump 14 (and/or the impeller face 50 wears), the suction liner 26 can be moved to reduce the nose gap 54. In some embodiments, the adjustment bolts 56 may be used to change the axial position of the suction liner 26.

As shown in FIGS. 2A, 2B, 3, and 4, in some embodiments, the suction liner 26 may be received in a space 58 at least partially defined between the interior side 48 of the second plate 38 and the impeller face 50. In some embodiments, as shown in FIG. 4, studs 62 may be used to circumferentially align or position the second plate 38 relative to the suction liner 26 and permit the suction liner 26 to move axially toward the impeller face 50 of the impeller 46 as the suction liner 26 is adjusted. As shown in FIGS. 2A and 2B, as the adjustment bolts 56 move axially toward the impeller face 50 by rotation of the adjustment bolts 56, the suction liner 26 is moved axially toward the impeller face 50. In this example manner, the nose gap 54 may be adjusted (e.g., reduced), for example, to offset an increase of the nose gap 54 resulting from wear of the liner wear surface 52 and/or the impeller 46.

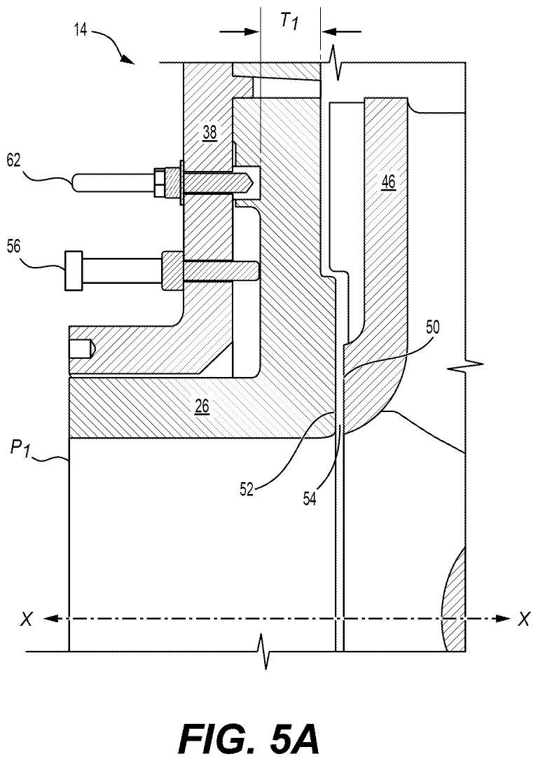

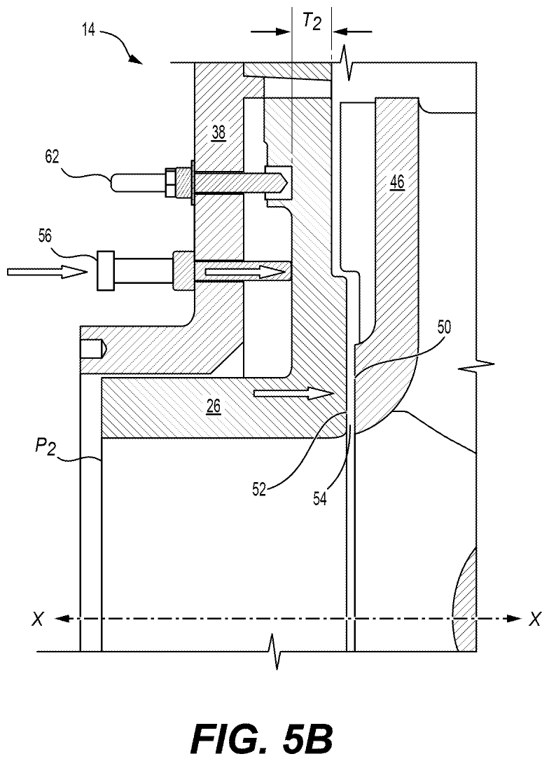

FIG. 5A and FIG. 5B are enlarged partial side section views of an example embodiment of a pump 14 including an example embodiment of an adjustable suction liner 26 and adjustment bolts 56 in a first axial position P₁ (FIG. 5A) and a second axial position P₂ (FIG. 5B) according to an aspect of the present disclosure. As shown in FIGS. 5A and 5B, in some embodiments, the nose gap 54 may be adjusted (e.g., reduced) by using the adjustment bolts 56, which may be moved axially toward the impeller face 50 by rotation of the adjustment bolts 56. As the adjustment bolts 56 are moved axially (to the right as shown), the suction liner 26 is moved axially toward the impeller face 50, resulting in the nose gap 54 being reduced, for example, to offset an increase of the nose gap 54 resulting from wear of the liner wear surface 52 and/or the impeller face 50.

Although an adjustable suction liner 26 may be used to axial reduce the nose gap 54 as material of the liner wear surface 52 and/or material of the impeller face 50 wears during operation of the pump 14, efficiently adjusting the axial position of the suction liner 26 may present challenges because it is difficult to determine the magnitude of the nose gap 54 because the nose gap 54 is within the interior of the assembled pump 14 and cannot be seen for measurement. As a result, one possible approach to axially adjusting the suction liner 26 to reduce the nose gap 54 includes slowly moving the suction liner 54 axially toward the impeller face 50 using the adjustment bolts 56 during operation of the pump 14, listening for contact between the liner wear surface 52 and the impeller face 50 (e.g., using a stethoscope), and thereafter allowing the liner wear surface 52 to move slightly away from the impeller face 50 by slightly reversing rotation of the adjustment bolts 56. Applicant has recognized, however, that such a process may result in a number of possible drawbacks, such as the need for an experienced technician, the inherent imprecision of the adjustment based on listening for contact between a stationary liner wear surface 52 against the rotating impeller 46, and the potential for significant damage to the pump 14 if, for example, the liner wear surface 52 and the rotating impeller 46 are tightened against one another an amount sufficient to damage the pump 14, which may lead to significant downtime and expense required to drain the medium from the pump 14, at least partially disassemble and inspect the pump 14, and in some instances, replace components of the pump 14 damaged by excessive contact between the liner wear surface 52 and the impeller 46. As a result of such potential consequences associated with adjusting the axial position of the suction liner 26 to reduce the nose gap 54, many operators either refrain from adjusting the axial position of the suction liner 26 or adjust the axial position in an overly conservative manner, which may result in relatively a large nose gap 54 that reduces the efficiency of operation of the pump 14 and/or increase wear rates of components of the pump 14.

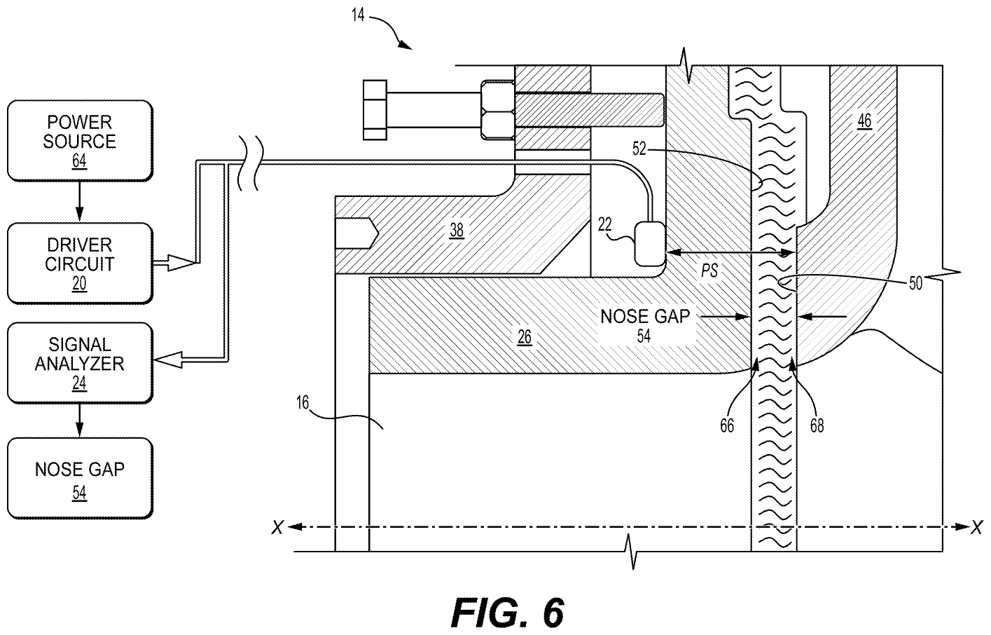

In some embodiments according to the present disclosure, the measurement assembly 12 may provide an improved process or method for determining the magnitude of the nose gap 54 between the liner wear surface 52 and the impeller face 50 of the impeller 46, for example, during operation of the pump 14. For example, FIG. 6 is a schematic partial side section view of an example embodiment of a measurement assembly 12 for measuring the nose gap 54 of an example embodiment of a pump 14 according to an aspect of the present disclosure. As schematically shown in FIG. 6, in some embodiments, the measurement assembly 12 includes one or more driver circuits 20 and one or more ultrasonic transducers 22 configured to emit ultrasonic pulses P into one or more components of the pump 14. A power source 64 (e.g., an electrical power source) may be provided to supply power to the one or more driver circuits 20 for use to cause the one or more ultrasonic transducers 22 to emit ultrasonic pulses P. The measurement assembly 12 further may include a signal analyzer 24 configured to receive pulse return signals P resulting from scattering and/or reflection of the emitted ultrasonic pulses due to passage through interfaces between one or more components of the pump 14 and/or the medium M being pumped. Based at least in part on the pulse return signals PS, the signal analyzer 24 may be configured to determine one or more thicknesses associated with components of the pump 14 and/or thicknesses associated with spaces between components of the pump 14, such as a nose gap 54 between the suction liner 26 and the impeller 46 of the pump 14. For example, the signal analyzer 24 may be configured to receive a first pulse return signal PS associated with an interface 66 between the suction liner 26 and the medium M, and receive a second pulse return signal PS associated with a surface of the impeller 46, such as the impeller face 50, and determine a size of the nose gap 54 based at least in part on the first pulse return signal and the second pulse return signal, for example, as described in more detail herein.

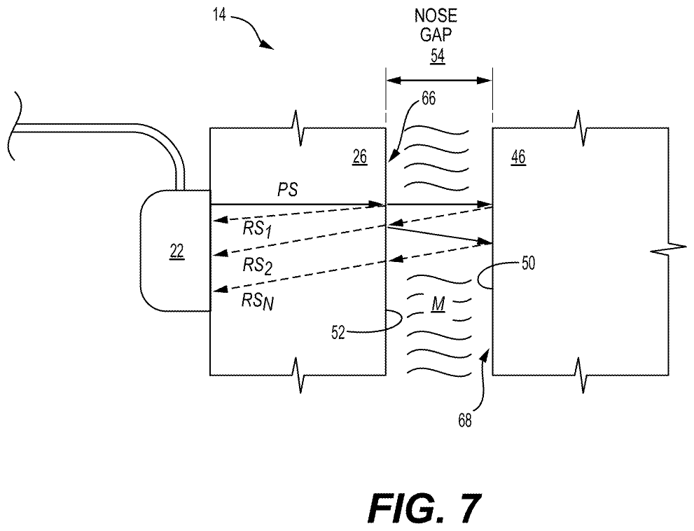

FIG. 7 is a schematic partial side section view of an example embodiment of measurement assembly 12 depicting an example ultrasonic pulse signal PS and example pulse return signals RS₁ and RS₂, and pulse reflection signals RS_{N} according to an aspect of the present disclosure. As shown, the ultrasonic transducer 22, coupled to a surface of the suction liner 26 opposite the liner wear surface 52, emits the ultrasonic pulse signal PS, which passes through the suction liner 26 and the medium M being pumped by the pump 14. As the ultrasonic pulse signal PS reaches the interface 66 between the suction liner 26 and medium M, a pulse return signal RS₁ is reflected back toward the ultrasonic transducer 22, which may include an ultrasonic receiver configured to generate an electrical signal indicative of the return pulse signal RS₁. For example, in some embodiments, the ultrasonic transducer 22 may be configured to convert the received pulse return signal RS₁ into an electrical signal indicative of the return pulse signal RS₁.

As the pulse signal PS continues through the medium M and contacts the impeller face 50 of the impeller 46, a pulse return signal RS₂ is reflected off the impeller face 50 back toward the ultrasonic transducer 22, and the ultrasonic receiver may generate an electrical signal indicative of the return pulse signal RS₂. For example, in some embodiments, the ultrasonic transducer 22 may be configured to convert the received pulse return signal RS₂ into an electrical signal indicative of the return pulse signal RS₂. In addition, in some embodiments, the ultrasonic pulse PS may reflect repeatedly between the suction liner 26 and the impeller 46 (e.g., main remain trapped between the suction liner 26 and the impeller 46), thereby creating one or more pulse reflection signals RS_{N}, for example, as schematically shown in FIG. 7.

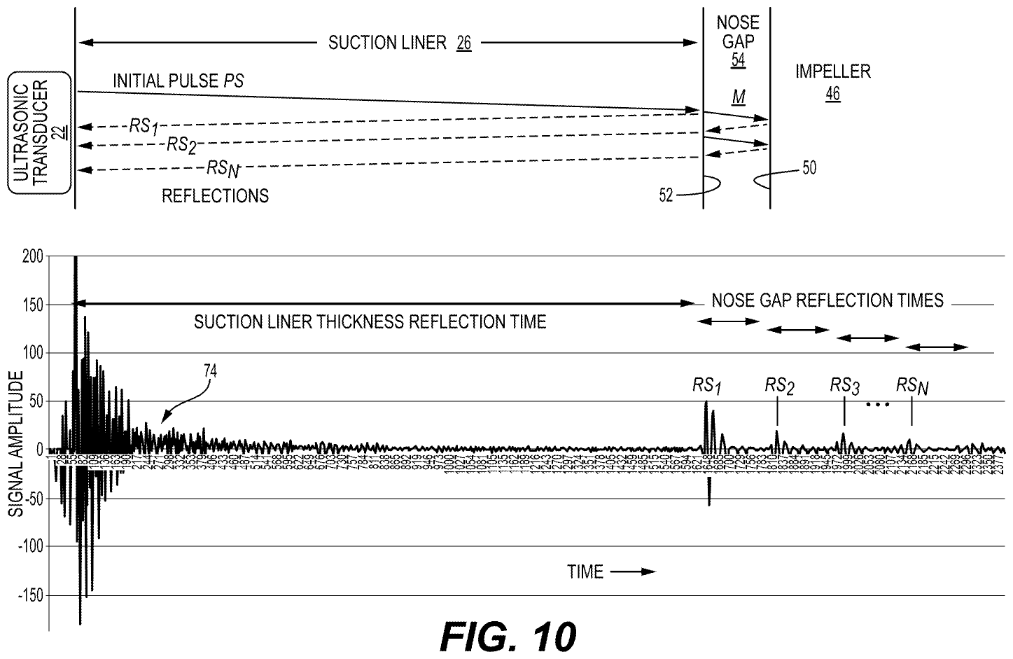

In some embodiments, the signal analyzer 24 may be in communication with the ultrasonic transducer 22, and the signal analyzer 24 may be configured to determine the size of the nose gap 54 based at least in part on one or more differences between the pulse return signal RS₁, the pulse return signal RS₂, and/or the one or more pulse reflection signals RS_{N}. In some embodiments, the one or more differences between the pulse return signal RS₁, the pulse return signal RS₂, and/or the one or more pulse reflection signals RS_{N} may be indicative of a time difference (e.g., differences between arrival times of the signals at the ultrasonic transducer 22), for example, as shown and described with respect to FIG. 10. Although for the purpose of clarity the pulse return signals and pulse reflection signals are described as being separate signals to differentiate between a portion of the pulse return signal RS₁ associated with the interface 66 between the liner wear surface 52 and the medium M, and a portion of the pulse return signal RS₂ associated with the impeller face 50, the pulse return signal and/or the one or more pulse reflection signals may be a single substantially continuous signal (e.g., a single combined signal), for example, as graphically depicted in FIG. 10.

For example, the pulse signal PS may travel through the thickness of the suction liner 26 at the speed of sound in the suction liner 26 and may partially reflect from the interface 66 between the suction liner 26 and medium M (e.g., as the pulse return signal RS₁) with some of the ultrasonic pulse traveling into the medium M at the speed of sound between the suction liner 26 and the impeller 46. The pulse signal PS may travel through the thickness of the medium M in the nose gap 54 at the speed of sound in the medium M and reflect from the impeller 46 (e.g., as the pulse return signal RS₂). The ultrasonic pulse that reflects from the impeller 46 may be returned through the medium M and impact the interface 66 between the suction liner 26 and medium M, sending the reflected pulse from the nose gap 54 back through the suction liner 26 to be received by the ultrasonic transducer 22 located, for example, on the outer surface of the suction liner 26.

In some embodiments, by using one or more ultrasonic transducers 22 to measure the nose gap 54 and/or the thickness of the suction liner 26, the amount of wear of the liner wear surface 52 of the suction liner 26 and/or the amount of wear of the impeller face 50 may be more accurately determined, for example, in real-time during operation of the pump 14. As a result, it may be possible to more accurately monitor the wear and/or determine how far to axially adjust the axial position of the suction liner 26 to reduce and/or minimize the magnitude of the nose gap 54. In addition, in some embodiments, this may result in adjusting the axial position of the suction liner 26 with more precision and confidence in preventing damage to the pump 14 when adjusting the suction liner 26 to reduce the nose gap 54.

In some embodiments, the signal analyzer 24 may be configured to account for differences in the speed of the return pulse signals through different media, such as the material of the suction liner 26 and the material of the medium M. Some embodiments may be configured to account for the coupling between the ultrasonic transducer 22 and the suction liner 26 and/or for one or more material properties of the suction liner 26. For example, if the material of the suction liner 26 is cast metal, inconsistencies in the crystal structure of the cast metal and/or microscopic voids within the cast metal may cause signal scattering or affect the speed of the return pulse signal(s). In some instances, there may be transition regions within the suction liner 26 due, for example, to heat treatment processes, which may result in carbide chunks in the material. Such material inconsistencies and/or poor coupling between the ultrasonic transducer 22 and the suction plate 26 may attenuate or cause the pulse signals and/or the return pulse signals to scatter in ways that may affect or degrade signal quality. In some embodiments, the signal analyzer 24 may be configured to account for one or more of the above-noted situations.

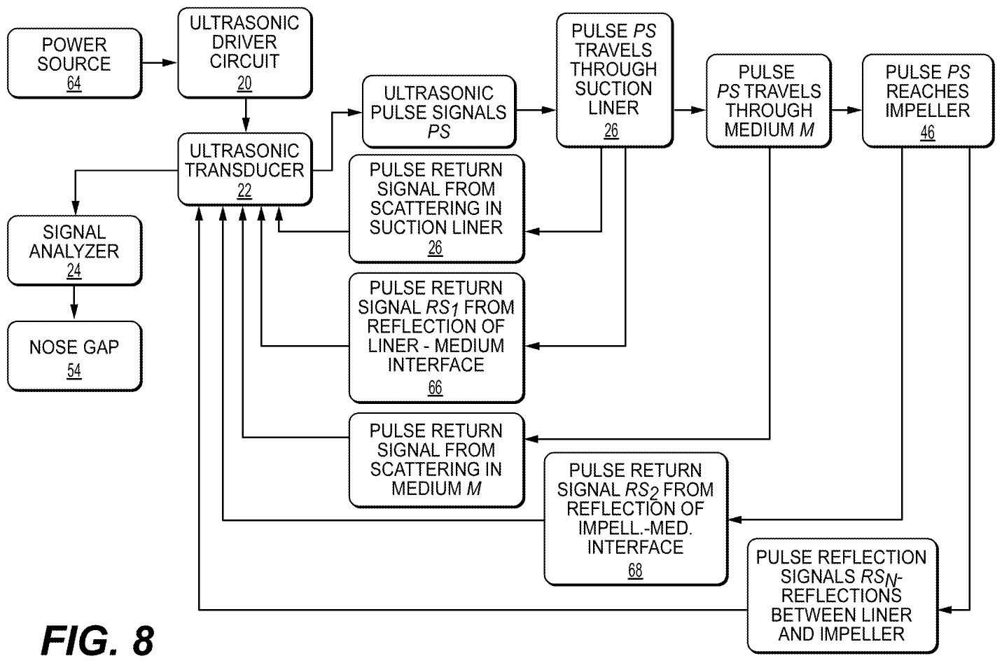

FIG. 8 is a flow diagram showing an example embodiment of a measurement assembly 12 for measuring the nose gap 54 and schematically depicting an ultrasonic pulse signal PS travelling through a suction liner 26 to an impeller 46 and pulse return signals RS according to an aspect of the present disclosure. As schematically shown in FIG. 8, the power source 64 supplies electrical power to the one or more ultrasonic driver circuits 20, which, in turn, cause the one or more ultrasonic transducers 22 to emit one or more ultrasonic pulse signals PS. The one or more ultrasonic pulse signals PS travel through the suction liner 26, resulting in a pulse return signal RS from scattering in the suction liner 26 and a pulse return signal RS₁ being reflected from the suction liner-to-medium M interface 66. The ultrasonic pulse signals PS continue to travel through the medium M and reach the impeller face 50 of the impeller 46, resulting in a pulse return signal RS from scattering in the medium M as the pulse signal PS travels through the medium M and a pulse return signal RS₂ being reflected from the impeller-to-medium interface 68. In addition, pulse reflection signals RS_{N} may reflected between the suction liner 26 and the impeller 46, for example, as depicted in FIGS. 7 and 10. The pulse return signals RS and/or the pulse reflection signals RS_{N} are detected by the ultrasonic transducer 22, which may include an ultrasonic receiver configured to generate one or more electrical signals (e.g., convert ultrasonic energy into one or more electrical signals) indicative of the ultrasonic pulse return signals RS and/or the pulse reflection signals RS_{N}. The one or more converted electrical signals may be communicated to the signal analyzer 24, which may be configured to determine the nose gap 54, for example, as described herein.

Although FIG. 8 schematically shows the signal analyzer 24 as a separate block from the ultrasonic transducer 22 for the purpose of description, it is contemplated that the signal analyzer 24 may either be physically incorporated into the ultrasonic transducer 22 (e.g., consistent with single element technology) or may be physically separate from the ultrasonic transducer 22 (e.g., consistent with dual element technology).

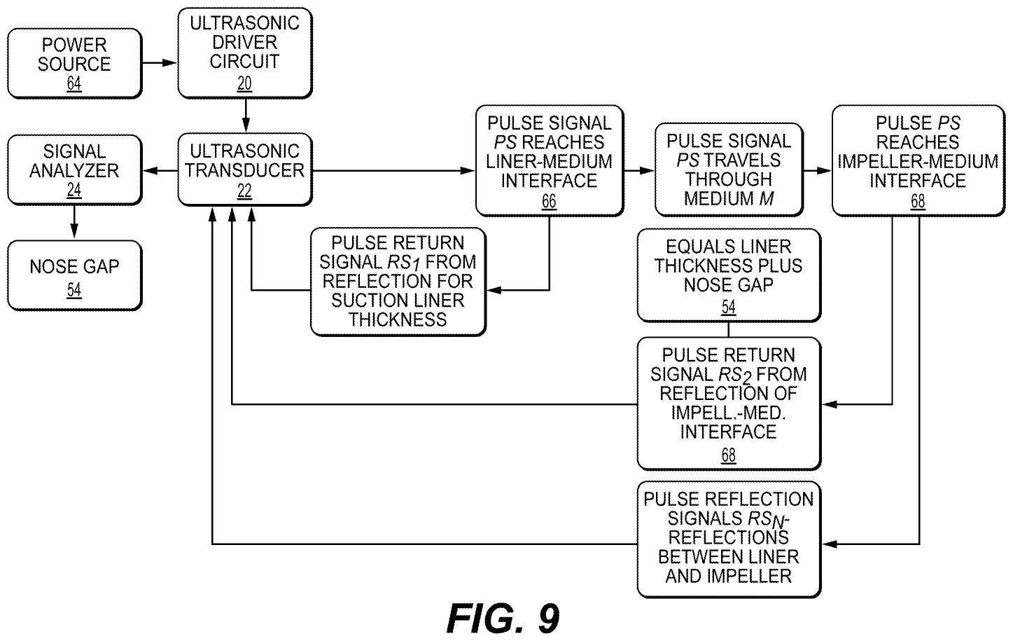

FIG. 9 is a flow diagram showing an example embodiment of a measurement assembly 12 for measuring the nose gap 54 and schematically depicting an ultrasonic pulse signal PS travelling through a suction liner 26 to an impeller 46 and pulse return signals RS and the pulse reflection signals RS_{N} being detected by a signal analyzer 24 according to an aspect of the present disclosure. As schematically shown in FIG. 9, the power source 64 supplies electrical power to the one or more ultrasonic driver circuits 20, which may cause one or more ultrasonic signal generators of one or more ultrasonic transducers 22 to emit one or more ultrasonic pulse signals PS. Although the one or more ultrasonic drivers circuits 20 and the one or more ultrasonic transducers 22 are shown as separate blocks in FIG. 9 for the purpose of explanation, as well as in other portions of the disclosure, the one or more ultrasonic driver circuits 20, the one or more ultrasonic signal generators, and/or the one or more ultrasonic transducers 22 may be integrated into a single device, for example, as understood by those skilled in the art.

The one or more ultrasonic pulse signals PS travel through the suction liner 26, resulting in a pulse return signal RS₁ being reflected in association with the thickness of the suction liner 26. The ultrasonic pulse signals PS continue to travel through the medium M and reach the interface 68 between the medium M and the impeller face 50 of the impeller 46, resulting a pulse return signal RS₂ from reflection of the pulse signal PS from the interface 68. As schematically depicted in FIG. 9, the pulse return signal RS₂ from the reflection from the interface 68 is indicative of the thickness of the suction liner 26 and the nose gap 54. In addition, pulse reflection signals RS_{N} may reflected between the suction liner 26 and the impeller 46, for example, as depicted in FIGS. 7 and 10. The pulse return signal RS₁ from the reflection at the interface 66 between the suction liner 26 and the medium M, the pulse return signal RS₂ from the reflection at the interface 68 between the impeller 46 and the medium M, and the pulse reflection signals RS_{N} are communicated to the signal analyzer 24, and the signal analyzer 24 determines the nose gap 54 based on differences between the pulse return signal RS₁, the pulse return signal RS₂, and/or the pulse reflection signals RS_{N}, for example, the time differences between one or more of the signals, as shown in FIG. 10.

In some embodiments, based on the differences, the distance from the ultrasonic transducer 22 and the interface 66 between the suction liner 26 and the medium M, and the distance between the interface 68 between the impeller 46 and the medium M may be determined, and the thickness of the nose gap 54 may be determined based on the difference between the distances, for example, by subtracting the distance associated with suction liner-to-medium M interface 66 (the thickness of the suction liner 26) from the distance associated with the impeller-to-medium M interface 68. Some embodiments may determine the magnitude of the nose gap 54 in this example manner or others.

Although FIG. 9 schematically shows the signal analyzer 24 as a separate block from the ultrasonic transducer 22 for the purpose of description, it is contemplated that the signal analyzer 24 may either be physically incorporated into the ultrasonic transducer 22 (e.g., consistent with single element technology) or may be physically separate from the ultrasonic transducer 22 (e.g., consistent with dual element technology).

FIG. 10 is a graph showing an example waveform 74 indicative of a pulse return signal RS magnitude versus time for an example embodiment of a measurement assembly 12 for measuring the nose gap 54 of a pump 14 according to an aspect of the present disclosure. For example, FIG. 10 shows a schematic travel path of an example ultrasonic pulse signal PS between an ultrasonic transducer 22, the interface 66 between the suction liner 26 and the medium M (FIG. 7) and an interface at the impeller surface 50 between the medium M and the impeller 46 (FIG. 7), as well as an example waveform 74 received by the ultrasonic transducer 22 (e.g., by a signal analyzer).

As shown in FIG. 10, the example pulse return signal RS includes several reflections, and in some embodiments, the signal analyzer 24 may be configured to distinguish between signal noise, signal scattering, and meaningful signal reflections. The example waveform 74 shown in FIG. 10 is representative of an example pulse return signal RS during an example operation of a pump 14. The example waveform 74 shown includes initial signal noise from signal scattering as the pulse signal PS passes through the suction liner 26 and a first pulse return signal RS₁, which is a reflection indicative of the interface 66 between the suction liner 26 and the medium M, which is indicative of the thickness of the suction liner 26 at the point where the pulse signal PS passes through the suction liner 26. A second pulse return signal RS₂, which is a reflection from the rotating impeller 46, is indicative of the interface 68 between the impeller 46 and the medium M, which is indicative of the thickness of the suction liner 26 plus the nose gap 54 at the point where the pulse signal PS passes through the medium M and reflects off the rotating impeller 46 and passes through the medium M and through the suction liner 26.

In addition, the pulse signal PS may also reflect one or more times between the suction liner 26 and the impeller 46, thereby creating one or more corresponding pulse reflection signals RS₃ through RS_{N}. As can be seen diagrammatically in FIG. 10, in some embodiments, the difference between the distance associated with second pulse return signal RS₂ and the distance associated with the first pulse return signal RS₁ may be used to determine the nose gap 54. In some embodiments, the first pulse return signal RS₁, the second pulse return signal RS₂, and the one or more pulse reflection signals RS_{N} may be used to determine the size of the nose gap 54, for example, as described herein. As noted herein, the signal analyzer 24 may be configured to account for conditions associated with the measurement assembly 12 and/or the construction of the pump 14, such as, for example, differences in the speed of the return pulse signals through different media, the coupling between the ultrasonic transducer 22 and the suction liner 26, and/or one or more material properties of the suction liner 26.

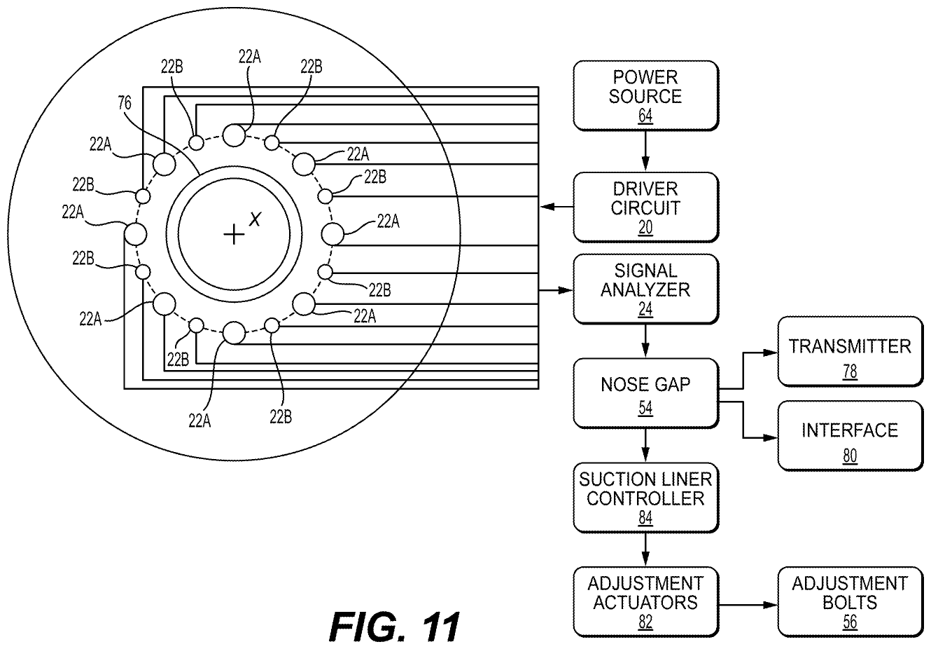

FIG. 11 is a schematic diagram of an example embodiment of a suction liner 26 and an example embodiment of a measurement assembly 12 for measuring the nose gap 54 of a pump 14 according to an aspect of the present disclosure. As shown in FIG. 11, the measurement assembly 12 may include a plurality of ultrasonic transducers 22 coupled to the suction liner 26, for example, between the second plate 38 and the suction liner 26 (see, e.g., FIGS. 2A and 2B), and at least some of the ultrasonic transducers 22 may be circumferentially spaced around the suction liner 26. This may provide nose gap measurements circumferentially around the suction liner 26. In some embodiments, the ultrasonic transducers 22 may be mounted to the suction liner 26 at respective positions radially close to a hub 76 of the suction liner 26, for example, so that the ultrasonic pulse signals PS pass through the suction liner 26 and medium M at a radial location that results in the pulse signals PS reflecting off a portion of the impeller 46 that is relatively planar (see, e.g., FIGS. 2A and 2B) and/or that has a predictable contour for reflection of the pulse signals PS. This may improve the accuracy of the determination of the magnitude of the nose gap 54.

As shown in FIG. 11, in some embodiments, the one or more ultrasonic transducers 22 may have operational power levels and/or operational frequencies that differ from one another. For example, the embodiment shown in FIG. 11 includes first ultrasonic transducers 22A having a first power level and a first frequency of operation, and second ultrasonic transducers 22B having a second power level and a second frequency of operation. The first power level of the first ultrasonic transducers 22A may differ from the second power level of the second ultrasonic transducers 22B and/or the first frequency of operation of the first ultrasonic transducers 22A may differ from the second frequency of operation of the second ultrasonic transducers 22B.

Although FIG. 11 shows two different types of ultrasonic transducers 22A and 22B, more different types and combinations of ultrasonic transducers are contemplated, for example, to provide results tailored to a particular configuration of pump assembly 10. Different types of ultrasonic transducers may be provided to address technical tradeoffs associated with various power levels or frequencies of ultrasonic transducers. For example, ultrasonic transducers having higher operational power and lower frequencies may have more penetration and may achieve improved transmission through obstructions, but they may exhibit reduced accuracy and may not be well-suited to measuring material thickness. The types of ultrasonic transducers 22 selected may be tailored to a particular pump assembly 10, for example, in order to achieve desired results.

As shown in FIG. 11, some embodiments of the measurement assembly 12 may include a transmitter 78 in communication with the one or more signal analyzers 24 and configured to communicate the size of the nose gap 54 to a location remote from the pump 14, such as a location elsewhere at the facility in which the pump 14 is being operated and/or at a monitoring or maintenance facility located at a geographic location separated from the facility. Such communication may be wired or wireless and may be implemented according to known communication protocols.

As shown in FIG. 11, some embodiments of measurement assembly 12 may include an interface 80 (e.g., a computer terminal, and/or a smart mobile device including a graphical user interface) for facilitating entry of information related to the measurement assembly 12 and/or communicating information related to the measurement assembly 12 to an operator or technician, either directly or via the transmitter 78. For example, a technician may enter queries regarding measurement of the nose gap 54 and receive related displayed responses.

As shown in FIG. 11, some embodiments of the pump assembly 10 may include one or more adjustment actuators 82 coupled to a respective adjustment bolt 56 and configured to cause the respective adjustment bolts 56 to move the suction liner 26 axially, for example, by causing the adjustment bolts 56 to rotate and push the suction liner 26 to a desired axial position relative to the impeller 46. For example, the one or more adjustment actuators 82 may include one or more motors (e.g., electric motors, pneumatic motors, or hydraulic motors) coupled to one or more screw jacks or similar devices coupled to the one or more adjustment bolts 56. The one or more motors may be actuated to cause the one or more screw jacks to rotate the one or more adjustment bolts, thereby causing the suction liner 26 to move axially to a desired position relative to the impeller 46. In some embodiments, the interface 80 may be used to control such adjustments.

Some embodiments of the pump assembly 10 further may include a suction liner controller 84, for example, as shown in FIG. 11. For example, the suction liner controller 84 may be in communication with the one or more signal analyzers 22 and/or the one or more adjustment actuators 82, and the suction liner controller 84 may be configured to control operation of the adjustment actuators 82. For example, the suction liner controller 84 may be configured to receive a nose gap signal indicative of the nose gap 54, and activate, based at least in part on the nose gap signal, one or more of the adjustment actuators 82 to cause the suction liner 26 to move axially to a desired position relative to the impeller 46 via rotation of the one or more adjustment bolts 56.

In some embodiments, the suction liner controller 84 may be configured to semi- or fully-autonomously maintain the axial position of the suction liner 26 within a desired or predetermined range of the impeller 46, for example, such that the nose gap 54 measured by the measurement assembly 12 remains within a desired range of nose gaps. For example, the suction liner controller 84 may be configured to activate, based at least in part on the nose gap signal, one or more of the adjustment actuators 82 to cause the suction liner 26 to move axially to substantially maintain the nose gap 54 within a desired range of nose gaps. In some embodiments, the interface 80 may be used by a technician or operator to specify the desired range of nose gaps. Alternatively, the range of nose gaps may be preselected, for example, by a manufacturer of the pump 14.

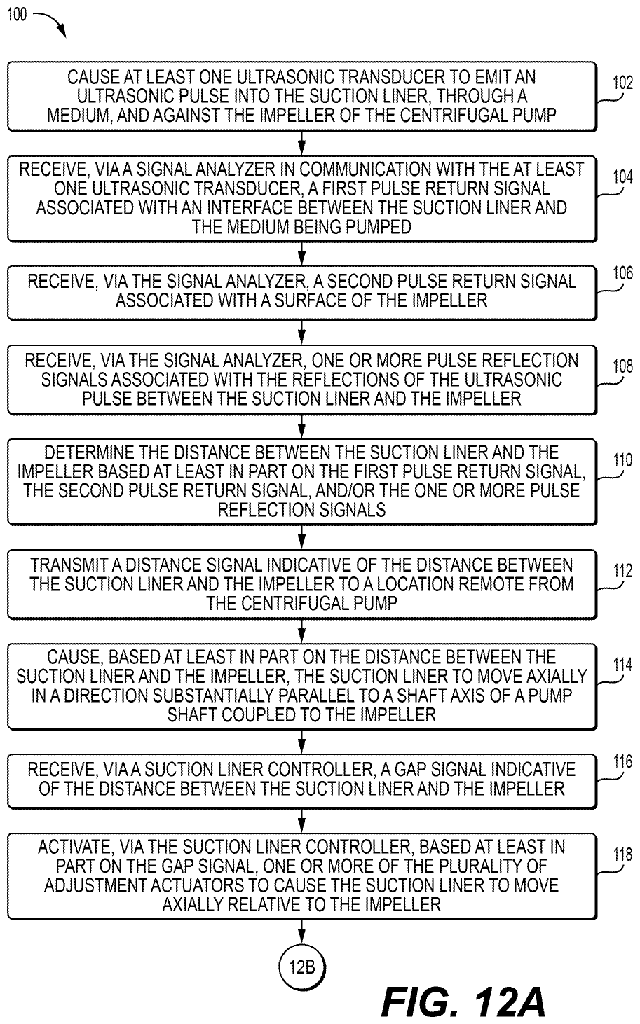

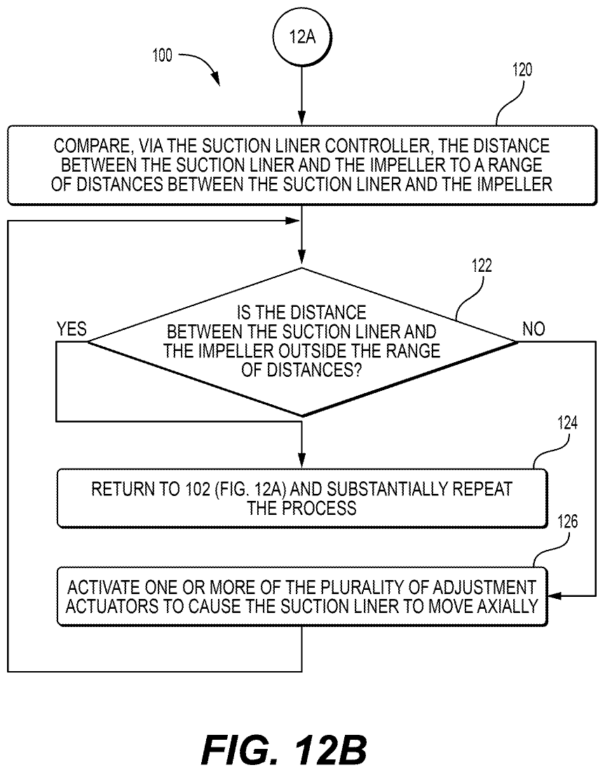

FIG. 12A and FIG. 12B are a block diagram of an example method 100 for measuring a distance between a suction liner and an impeller of a slurry pump, according to an aspect of the disclosure. The example method 100 is illustrated as a collection of blocks in a logical flow graph, which represent a sequence of operations. In some embodiments of the method 100, one or more of the blocks may be manually and/or automatically executed. In the context of software, where applicable, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described blocks can be combined in any order and/or in parallel to implement the method.

The example method 100, at 102, may include causing at least one ultrasonic transducer to emit an ultrasonic pulse into the suction liner of the slurry pump, through a medium between the suction liner and the impeller of the slurry pump, and against the impeller of the slurry pump, for example, as described herein.

At 104, the example method 100 further may include receiving, via a signal analyzer in communication with the at least one ultrasonic transducer, a first pulse return signal associated with an interface between the suction liner and the medium being pumped, for example, as described herein.

The example method 100, at 106, also may include receiving, via the signal analyzer, a second pulse return signal associated with a surface of the impeller, for example, as described herein.

At 108, the example method 100 further may include receiving, via a signal analyzer in communication with the at least one ultrasonic transducer, one or more pulse reflection signals associated with reflections of the ultrasonic pulse between the suction liner and the impeller, for example, as described herein.

At 110, the example method 100 further may include determining the distance between the suction liner and the impeller based at least in part on the first pulse return signal, the second pulse return signal, and/or the one or more pulse reflection signals, for example, as described herein. For example, determining the distance between the suction liner and the impeller may include determining one or more differences between one or more of the first pulse return signal, the second return signal, or the one or more pulse reflection signals, which, in some embodiments, may include determining one or more time differences between the first pulse return signal, the second return signal, and/or the one or more pulse reflection signals, for example, as described herein.

In some embodiments, the at least one ultrasonic transducer may include a plurality of ultrasonic transducers coupled to the suction liner at locations spaced circumferentially around the suction liner, and determining the distance between the suction liner and the impeller may include determining respective distances between the suction liner and the impeller at the respective locations spaced circumferentially around the suction liner, based at least in part on respective first pulse return signals, respective second pulse return signals, and/or respective pulse reflection signals, for example, as described herein. In some embodiments, causing the at least one ultrasonic transducer to emit an ultrasonic pulse and determining the one or more differences occurs during operation of the slurry pump, for example, as described herein.

The example method 100, at 112, may further include transmitting a distance signal indicative of the distance between the suction liner and the impeller to a location remote from the slurry pump, for example, as described herein.

In some embodiments, the example method 100 for measuring the distance between the suction liner and the impeller may be incorporated into a method for adjusting the distance between the suction liner and the impeller of the slurry pump. In some such embodiments, the method 100 further may include, at 114, causing, based at least in part on the distance between the suction liner and the impeller, the suction liner to move axially in a direction substantially parallel to a shaft axis of a pump shaft coupled to the impeller, for example, as described herein. For example, causing the suction liner to move axially may include rotating a plurality of adjustment bolts contacting a back surface of the suction liner opposite the impeller, to thereby move the suction liner axially relative to the impeller (e.g., toward the impeller). In some embodiments, rotating the plurality of adjustment bolts may include activating a plurality of adjustment actuators coupled to respective adjustment bolts to cause the adjustment bolts to move the suction liner axially relative to the impeller.

The example method 100, at 116, also may include receiving, via a suction liner controller in communication with the signal analyzer and the plurality of adjustment actuators, a gap signal indicative of the distance between the suction liner and the impeller, for example, as described herein.

At 118, the example method 100 also may include activating, via the suction liner controller, based at least in part on the gap signal, one or more of the plurality of adjustment actuators to cause the suction liner to move axially relative to the impeller, for example, as described herein.

The example method 100, at 120 (FIG. 12B), further may include comparing, via the suction liner controller, the distance between the suction liner and the impeller to a range of distances between the suction liner and the impeller, for example, as described herein.

At 122, the example method 100 also may include determining, based on the comparison at 120, whether the distance between the suction liner and the impeller is outside the range of distances. This may include determining the nose gap and determining whether the nose gap is within a range of nose gaps, for example, as described herein.

If at 122 it is determined that the distance between the suction liner and the impeller is within the range of distances, at 124, the example method 100 further may include returning to 102 and substantially repeating the process. If at 122 it is determined that the distance between the suction liner and the impeller is outside the range of distances, at 126, the example method 100 also may include activating one or more of the plurality of adjustment actuators to cause the suction liner to move axially, for example, as described herein, and return to 122 to determine whether the distance between the suction liner and the impeller is outside the range of distances.

In some embodiments, the method for adjusting the distance between the suction liner and the impeller of the slurry pump may not incorporate at least some aspects of the above-noted method 100 for measuring the distance between the suction liner and the impeller of a slurry pump. For example, measurement of the distance may be measured or estimated using an alternative method.

It should be appreciated that at least some subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, mobile telephone devices, tablet computing devices, special-purposed hardware devices, network appliances, and the like.

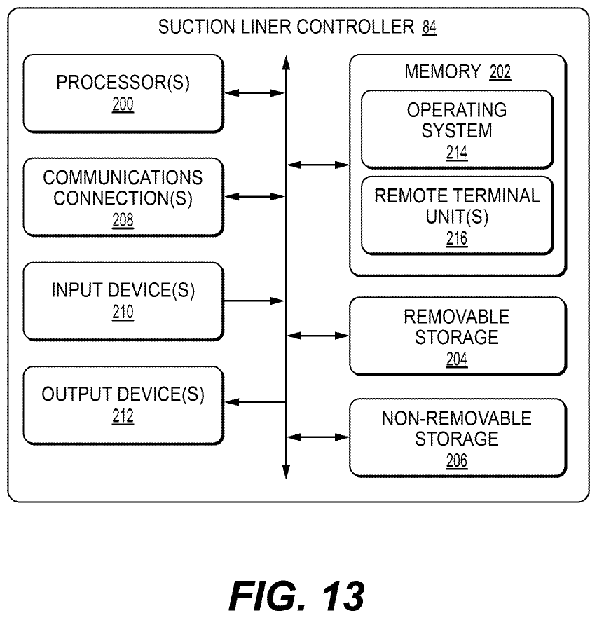

FIG. 13 is a schematic diagram of an example suction liner controller 84 configured to at least partially control movement of a suction liner 26, according to embodiments of the disclosure. The suction liner controller 84 may include one or more of the controllers described herein. The suction liner controller 84 may include one or more processor(s) 200 configured to execute certain operational aspects associated with implementing certain systems and methods described herein. The processor(s) 200 may communicate with a memory 202. The processor(s) 200 may be implemented and operated using appropriate hardware, software, firmware, or combinations thereof. Software or firmware implementations may include computer-executable or machine-executable instructions written in any suitable programming language to perform the various functions described. In some examples, instructions associated with a function block language may be stored in the memory 202 and executed by the processor(s) 200.

The memory 202 may be used to store program instructions that are loadable and executable by the processor(s) 200, as well as to store data generated during the execution of these programs. Depending on the configuration and type of the suction liner controller 84, the memory 202 may be volatile (such as random access memory (RAM)) and/or non-volatile (such as read-only memory (ROM), flash memory, etc.). In some examples, the memory devices may include additional removable storage 204 and/or non-removable storage 206 including, but not limited to, magnetic storage, optical disks, and/or tape storage. The disk drives and their associated computer readable media may provide non-volatile storage of computer-readable instructions, data structures, program modules, and other data for the devices. In some implementations, the memory 202 may include multiple different types of memory, such as static random access memory (SRAM), dynamic random access memory (DRAM), or ROM.

The memory 202, the removable storage 204, and the non-removable storage 206 are all examples of computer-readable storage media. For example, computer-readable storage media may include volatile and non-volatile, removable, and non-removable media implemented in any method or technology for storage of information, such as computer-readable instructions, data structures, program modules, or other data. Additional types of computer storage media that may be present may include, but are not limited to, programmable random access memory (PRAM), SRAM, DRAM, RAM, ROM, electrically erasable programmable read-only memory (EEPROM), flash memory, or other memory technology, compact disc read-only memory (CD-ROM), digital versatile discs (DVD) or other optical storage, magnetic cassettes, magnetic tapes, magnetic disk storage or other magnetic storage devices, or any other medium, which may be used to store the desired information and which may be accessed by the devices. Combinations of any of the above should also be included within the scope of computer-readable media.

The suction liner controller 84 may also include one or more communication connection(s) 208 that may facilitate a control device (not shown) to communicate with devices or equipment capable of communicating with the suction liner controller 84. The suction liner controller 84 may also include a computer system (not shown). Connections may also be established via various data communication channels or ports, such as USB or COM ports to receive cables connecting the suction liner controller 84 to various other devices on a network. In some examples, the suction liner controller 84 may include Ethernet drivers that enable the suction liner controller 84 to communicate with other devices on the network. According to various examples, communication connections 208 may be established via a wired and/or wireless connection on the network.

The suction liner controller 84 also may include one or more input devices 210, such as a keyboard, mouse, pen, voice input device, gesture input device, and/or touch input device. It may further include one or more output devices 212, such as a display, printer, and/or speakers. In some examples, computer-readable communication media may include computer-readable instructions, program modules, or other data transmitted within a data signal, such as a carrier wave or other transmission. As used herein, however, computer-readable storage media may not include computer-readable communication media.

Turning to the contents of the memory 202, the memory 202 may include, but is not limited to, an operating system (OS) 214 and one or more application programs or services for implementing the features and embodiments disclosed herein. Such applications or services may include remote terminal units 216 for executing certain systems and methods for controlling operation of the measurement assembly 12 (e.g., semi- or full-autonomously controlling operation of the measurement assembly 12), for example, upon receipt of one or more control signals generated by the suction liner controller 84. In some embodiments, one or more remote terminal unit(s) 216 may be located on one or more components of the suction liner controller 84. The remote terminal unit(s) 216 may reside in the memory 202 or may be independent of the suction liner controller 84. In some examples, the remote terminal unit(s) 216 may be implemented by software that may be provided in configurable control block language and may be stored in non-volatile memory. When executed by the processor(s) 200, the remote terminal unit(s) 216 may implement the various functionalities and features associated with the suction liner controller 84 described herein.

As desired, embodiments of the disclosure may include a suction liner controller 84 with more or fewer components than are illustrated in FIG. 13. Additionally, certain components of the example suction liner controller 84 shown in FIG. 13 may be combined in various embodiments of the disclosure. The suction liner controller 84 of FIG. 13 is provided by way of example only.

References are made to block diagrams of systems, methods, apparatuses, and computer program products according to example embodiments. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a non-transitory computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide task, acts, actions, or operations for implementing the functions specified in the block or blocks.

One or more components of the systems and one or more elements of the methods described herein may be implemented through an application program running on an operating system of a computer. They may also be practiced with other computer system configurations, including hand-held devices, multiprocessor systems, microprocessor-based or programmable consumer electronics, mini-computers, mainframe computers, and the like.

Application programs that are components of the systems and methods described herein may include routines, programs, components, data structures, etc. that may implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks can be performed by remote processing devices linked through a communications network.

### Additional Examples

An example measurement assembly for measuring a nose gap of a centrifugal pump may include at least one ultrasonic transducer configured to be coupled to a suction liner of the centrifugal pump, and a driver circuit electrically connected to the at least one ultrasonic transducer and configured to cause the at least one ultrasonic transducer to emit an ultrasonic pulse into the suction liner, through a medium in the nose gap, and against an impeller of the centrifugal pump. The measurement assembly also may include a signal analyzer in communication with the at least one ultrasonic transducer. The signal analyzer may be configured to receive a first pulse return signal associated with an interface between the suction liner and the medium, receive a second pulse return signal associated with a surface of the impeller, receive one or more pulse reflection signals associated with reflections of the ultrasonic pulse between the suction liner and the impeller, and determine a size of the nose gap based at least in part on one or more of the first pulse return signal, the second pulse return signal, or the one or more pulse reflection signals.

The example measurement assembly above, wherein the signal analyzer may be configured to determine the size of the nose gap based at least in part on one or more differences between the first pulse return signal, the second return signal, and the one or more pulse reflection signals, and wherein the one or more differences include one or more time differences.

Any one of the example measurement assemblies above, wherein the at least one ultrasonic transducer may include a plurality of ultrasonic transducers, and the plurality of ultrasonic transducers may be configured to be circumferentially spaced around the suction liner.

Any one of the example measurement assemblies above, wherein the at least one ultrasonic transducer may include a first ultrasonic transducer having a first power level and a first frequency of operation, and a second ultrasonic transducer having a second power level and a second frequency of operation, wherein at least one of the first power level differs from the second power level or the first frequency of operation differs from the second frequency of operation.

Any one of the example measurement assemblies above, further including a transmitter in communication with the signal analyzer and configured to communicate the size of the nose gap to a location remote from the centrifugal pump.

Any one of the example measurement assemblies above, wherein the signal analyzer is configured to determine the size of the nose gap during operation of the centrifugal pump.

An example centrifugal pump assembly may include a casing defining a substantially annular interior chamber, a first plate coupled to the casing and defining a first bore, and a second plate coupled to the casing opposite the first plate and defining an inlet bore configured to receive a medium being pumped. The example centrifugal pump assembly further may include a pump shaft having a shaft axis, with the pump shaft being received through the first bore and being configured to rotate about the shaft axis. The example centrifugal pump assembly also may include an impeller received in the substantially annular interior chamber and coupled to the pump shaft, with the impeller defining an impeller face facing toward an interior side of the second plate.

The example centrifugal pump assembly further may include a suction liner movably coupled to the second plate and defining a liner wear surface positioned adjacent the impeller face of the impeller, such that the liner wear surface and the impeller face at least partially define a nose gap therebetween. The example centrifugal pump assembly also may include a measurement assembly for measuring the nose gap.

The measurement assembly of any of the example centrifugal pump assemblies may include at least one ultrasonic transducer configured to be coupled to the suction liner, and a driver circuit electrically connected to the at least one ultrasonic transducer and configured to cause the at least one ultrasonic transducer to emit an ultrasonic sound wave into the suction liner, through a medium in the nose gap, and against the impeller face. The measurement assembly further may include a signal analyzer in communication with the at least one ultrasonic transducer and configured to receive a first pulse return signal associated with an interface between the suction liner and the medium, receive a second pulse return signal associated with the impeller face, and receive one or more pulse reflection signals associated with reflections of the ultrasonic sound wave between the suction liner and the impeller. The signal analyzer further may be configured to determine a size of the nose gap based at least in part on one or more of the first pulse return signal, the second pulse return signal, or the one or more pulse reflection signals.

The example centrifugal pump assemblies above, wherein the signal analyzer is configured to determine the size of the nose gap based at least in part on one or more differences between the first pulse return, the second pulse return signal, or the one or more pulse reflection signals, and wherein the one or more differences include one or more time differences.

Any one of the example measurement assemblies of any of the example centrifugal pump assemblies above, wherein the at least one ultrasonic transducer includes a plurality of ultrasonic transducers, and the plurality of ultrasonic transducers are coupled to the suction liner between the second plate and the suction liner and are circumferentially spaced around the suction liner.

Any one of the example measurement assemblies of any of the example centrifugal pump assemblies above, wherein the at least one ultrasonic transducer includes a first ultrasonic transducer having a first power level and a first frequency of operation, and a second ultrasonic transducer having a second power level and a second frequency of operation. The first power level differs from the second power level and/or the first frequency of operation differs from the second frequency of operation.

Any one of the example measurement assemblies of any of the example centrifugal pump assemblies above, further including a transmitter in communication with the signal analyzer and configured to communicate the size of the nose gap to a location remote from the centrifugal pump.

Any one of the example measurement assemblies of any of the example centrifugal pump assemblies above, wherein the signal analyzer is configured to determine the size of the nose gap during operation of the centrifugal pump.

Any one of the example centrifugal pump assemblies above, wherein the suction liner is movably coupled to the second plate via a plurality of adjustment bolts extending through the second plate and contacting a back surface of the suction liner opposite the wear surface, with the adjustment bolts being configured to cause the suction liner to move axially in a direction substantially parallel to the shaft axis of the pump shaft.

Any one of the example centrifugal pump assemblies above, further including a plurality of adjustment actuators, with each of the plurality of adjustment actuators being coupled to a respective adjustment bolt and being configured to cause the respective adjustment bolts to move the suction liner axially.

Any one of the example centrifugal pump assemblies above, further including a suction liner controller in communication with the signal analyzer and the plurality of adjustment actuators. The suction liner controller may be configured to receive a nose gap signal indicative of the nose gap, and activate, based at least in part on the nose gap signal, one or more of the adjustment actuators to cause the suction liner to move axially.

Any one of the example centrifugal pump assemblies above, wherein the suction liner controller is configured to activate, based at least in part on the nose gap signal, one or more of the adjustment actuators to cause the suction liner to move axially to substantially maintain the nose gap within a range of nose gaps.

An example method for measuring a distance between a suction liner and an impeller of a centrifugal pump, may include causing at least one ultrasonic transducer to emit an ultrasonic pulse into the suction liner of the centrifugal pump, through a medium between the suction liner and the impeller of the centrifugal pump, and against the impeller of the centrifugal pump. The example method further may include receiving, via a signal analyzer in communication with the at least one ultrasonic transducer, a first pulse return signal associated with an interface between the suction liner and the medium, receiving, via the signal analyzer, a second pulse return signal associated with a surface of the impeller, and receiving, via the signal analyzer, one or more pulse reflection signals associated with reflections of the ultrasonic pulse between the suction liner and the impeller. The example method also may include determining the distance between the suction liner and the impeller based at least in part on one or more of the first pulse return signal, the second pulse return signal, or the one or more pulse reflection signals.

The example method for measuring a distance between a suction liner and an impeller of a centrifugal pump above, wherein determining the distance between the suction liner and the impeller includes determining one or more differences between one or more of the first pulse return signal, the second pulse return signal, or the one or more pulse reflection signals, and wherein determining the one or more differences comprises determining one or more time differences.

Any one of the example methods for measuring a distance between a suction liner and an impeller of a centrifugal pump above, wherein the at least one ultrasonic transducer includes a plurality of ultrasonic transducers coupled to the suction liner at locations spaced circumferentially around the suction liner, and wherein determining the distance between the suction liner and the impeller includes determining respective distances between the suction liner and the impeller at the respective locations spaced circumferentially around the suction liner, based at least in part on respective first pulse return signals and respective second pulse return signals.

Any one of the example methods for measuring a distance between a suction liner and an impeller of a centrifugal pump above, further including transmitting a distance signal indicative of the distance between the suction liner and the impeller to a location remote from the centrifugal pump.

Any one of the example methods for measuring a distance between a suction liner and an impeller of a centrifugal pump above, wherein causing the at least one ultrasonic transducer to emit an ultrasonic pulse and determining the one or more differences occurs during operation of the centrifugal pump.

An example method for adjusting a distance between a suction liner and an impeller of a centrifugal pump, may include causing at least one ultrasonic transducer to emit an ultrasonic pulse into the suction liner of the centrifugal pump, through a medium between the suction liner and the impeller of the centrifugal pump, and against the impeller of the centrifugal pump. The example method further may include receiving, via a signal analyzer in communication with the at least one ultrasonic transducer, a first pulse return signal associated with an interface between the suction liner and the medium, receiving, via the signal analyzer, a second pulse return signal associated with a surface of the impeller, and receiving, via the signal analyzer, one or more pulse reflection signals associated with reflections of the ultrasonic pulse between the suction liner and the impeller. The example method also may include determining the distance between the suction liner and the impeller based at least in part on one or more of the first pulse return signal, the second pulse return signal, or the one or more pulse reflection signals, and causing, based at least in part on the distance between the suction liner and the impeller, the suction liner to move axially in a direction substantially parallel to a shaft axis of a pump shaft coupled to the impeller.

The example method for adjusting a distance between a suction liner and an impeller of a centrifugal pump above, wherein determining the distance between the suction liner and the impeller includes determining one or more differences between one or more of the first pulse return signal, the second pulse return signal, or the one or more pulse reflection signals, and wherein determining the one or more differences includes determining one or more time differences.

Any one of the example methods for adjusting a distance between a suction liner and an impeller of a centrifugal pump above, wherein causing the suction liner to move axially includes rotating a plurality of adjustment bolts contacting a back surface of the suction liner opposite the impeller.

Any one of the example methods for adjusting a distance between a suction liner and an impeller of a centrifugal pump above, wherein rotating the plurality of adjustment bolts includes activating a plurality of adjustment actuators coupled to the adjustment bolts to cause the adjustment bolts to move the suction liner axially.

Any one of the example methods for adjusting a distance between a suction liner and an impeller of a centrifugal pump above, further including receiving, via a suction liner controller in communication with the signal analyzer and the plurality of adjustment actuators, a gap signal indicative of the distance between the suction liner and the impeller, and activating, via the suction liner controller, based at least in part on the gap signal, one or more of the plurality of adjustment actuators to cause the suction liner to move axially.

Any one of the example methods for adjusting a distance between a suction liner and an impeller of a centrifugal pump above, further including comparing, via the suction liner controller, the distance between the suction liner and the impeller to a range of distances between the suction liner and the impeller, and when the distance between the suction liner and the impeller is outside the range of distances, activating one or more of the plurality of adjustment actuators to cause the suction liner to move axially such that the distance between the suction liner and the impeller is within the range of distances.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present disclosure as set forth in the appended claims.

What is claimed is:

1. A measurement assembly for measuring a nose gap of a centrifugal pump, the measurement assembly comprising:
at least one ultrasonic transducer configured to be coupled to a suction liner of the centrifugal pump;
a driver circuit electrically connected to the at least one ultrasonic transducer and configured to cause the at least one ultrasonic transducer to emit an ultrasonic pulse into the suction liner, through a medium in the nose gap, and against an impeller of the centrifugal pump; and
a signal analyzer in communication with the at least one ultrasonic transducer and configured to:
receive a first pulse return signal associated with an interface between the suction liner and the medium;
receive a second pulse return signal associated with a surface of the impeller;
receive one or more pulse reflection signals associated with reflections of the ultrasonic pulse between the suction liner and the impeller; and
determine a size of the nose gap based at least in part on one or more of the first pulse return signal, the second pulse return signal, or the one or more pulse reflection signals.

2. The measurement assembly of claim 1, wherein the signal analyzer is configured to determine the size of the nose gap based at least in part on one or more differences between the first pulse return signal, the second return signal, and the one or more pulse reflection signals, and wherein the one or more differences include one or more time differences.

3. The measurement assembly of claim 1, wherein the at least one ultrasonic transducer comprises a plurality of ultrasonic transducers, and the plurality of ultrasonic transducers are configured to be circumferentially spaced around the suction liner.

4. The measurement assembly of claim 1, wherein the at least one ultrasonic transducer comprises:
a first ultrasonic transducer having a first power level and a first frequency of operation; and
a second ultrasonic transducer having a second power level and a second frequency of operation, wherein at least one of:
the first power level differs from the second power level, or
the first frequency of operation differs from the second frequency of operation.

5. The measurement assembly of claim 1, further comprising a transmitter in communication with the signal analyzer and configured to communicate the size of the nose gap to a location remote from the centrifugal pump.

6. The measurement assembly of claim 1, wherein the signal analyzer is configured to determine the size of the nose gap during operation of the centrifugal pump.

7. A centrifugal pump assembly comprising:
a casing defining a substantially annular interior chamber;
a first plate coupled to the casing and defining a first bore;
a second plate coupled to the casing opposite the first plate and defining an inlet bore configured to receive a medium being pumped;
a pump shaft having a shaft axis, the pump shaft being received through the first bore and being configured to rotate about the shaft axis;
an impeller received in the substantially annular interior chamber and coupled to the pump shaft, the impeller defining an impeller face facing toward an interior side of the second plate;
a suction liner movably coupled to the second plate and defining a liner wear surface positioned adjacent the impeller face of the impeller, such that the liner wear surface and the impeller face at least partially define a nose gap therebetween; and
a measurement assembly for measuring the nose gap, the measurement assembly comprising:
at least one ultrasonic transducer configured to be coupled to the suction liner;
a driver circuit electrically connected to the at least one ultrasonic transducer and configured to cause the at least one ultrasonic transducer to emit an ultrasonic sound wave into the suction liner, through a medium in the nose gap, and against the impeller face; and
a signal analyzer in communication with the at least one ultrasonic transducer and configured to:
receive a first pulse return signal associated with an interface between the suction liner and the medium;
receive a second pulse return signal associated with the impeller face;
receive one or more pulse reflection signals associated with reflections of the ultrasonic sound wave between the suction liner and the impeller; and
determine a size of the nose gap based at least in part on one or more of the first pulse return signal, the second pulse return signal, or the one or more pulse reflection signals.

8. The centrifugal pump assembly of claim 7, wherein the signal analyzer is configured to determine the size of the nose gap based at least in part on one or more differences between the first pulse return, the second pulse return signal, or the one or more pulse reflection signals, and wherein the one or more differences include one or more time differences.

9. The centrifugal pump assembly of claim 7, wherein the at least one ultrasonic transducer comprises a plurality of ultrasonic transducers, and the plurality of ultrasonic transducers are coupled to the suction liner between the second plate and the suction liner and are circumferentially spaced around the suction liner.

10. The centrifugal pump assembly of claim 7, wherein the at least one ultrasonic transducer comprises:
a first ultrasonic transducer having a first power level and a first frequency of operation; and
a second ultrasonic transducer having a second power level and a second frequency of operation, wherein at least one of:
the first power level differs from the second power level; or
the first frequency of operation differs from the second frequency of operation.

11. The centrifugal pump assembly of claim 7, further comprising a transmitter in communication with the signal analyzer and configured to communicate the size of the nose gap to a location remote from the centrifugal pump.

12. The centrifugal pump assembly of claim 7, wherein the signal analyzer is configured to determine the size of the nose gap during operation of the centrifugal pump.

13. The centrifugal pump assembly of claim 7, wherein the suction liner is movably coupled to the second plate via a plurality of adjustment bolts extending through the second plate and contacting a back surface of the suction liner opposite the wear surface, the adjustment bolts being configured to cause the suction liner to move axially in a direction substantially parallel to the shaft axis of the pump shaft.

14. The centrifugal pump assembly of claim 13, further comprising a plurality of adjustment actuators, each of the plurality of adjustment actuators being coupled to a respective adjustment bolt and being configured to cause the respective adjustment bolts to move the suction liner axially.

15. The centrifugal pump assembly of claim 14, further comprising a suction liner controller in communication with the signal analyzer and the plurality of adjustment actuators, the suction liner controller being configured to:
receive a nose gap signal indicative of the nose gap; and
activate, based at least in part on the nose gap signal, one or more of the adjustment actuators to cause the suction liner to move axially.

16. The centrifugal pump assembly of claim 15, wherein the suction liner controller is configured to activate, based at least in part on the nose gap signal, one or more of the adjustment actuators to cause the suction liner to move axially to substantially maintain the nose gap within a range of nose gaps.

17. A method for measuring a distance between a suction liner and an impeller of a centrifugal pump, the method comprising:
causing at least one ultrasonic transducer to emit an ultrasonic pulse into the suction liner of the centrifugal pump, through a medium between the suction liner and the impeller of the centrifugal pump, and against the impeller of the centrifugal pump;
receiving, via a signal analyzer in communication with the at least one ultrasonic transducer, a first pulse return signal associated with an interface between the suction liner and the medium;
receiving, via the signal analyzer, a second pulse return signal associated with a surface of the impeller;
receiving, via the signal analyzer, one or more pulse reflection signals associated with reflections of the ultrasonic pulse between the suction liner and the impeller; and
determining the distance between the suction liner and the impeller based at least in part on one or more of the first pulse return signal, the second pulse return signal, or the one or more pulse reflection signals.

18. The method of claim 17, wherein determining the distance between the suction liner and the impeller comprising determining one or more differences between one or more of the first pulse return signal, the second pulse return signal, or the one or more pulse reflection signals, and wherein determining the one or more differences comprises determining one or more time differences.

19. The method of claim 17, wherein:
the at least one ultrasonic transducer comprises a plurality of ultrasonic transducers coupled to the suction liner at locations spaced circumferentially around the suction liner; and
determining the distance between the suction liner and the impeller comprises determining respective distances between the suction liner and the impeller at the respective locations spaced circumferentially around the suction liner, based at least in part on respective first pulse return signals and respective second pulse return signals.

20. The method of claim 17, further comprising transmitting a distance signal indicative of the distance between the suction liner and the impeller to a location remote from the centrifugal pump.

21. The method of claim 18, wherein causing the at least one ultrasonic transducer to emit an ultrasonic pulse and determining the one or more differences occurs during operation of the centrifugal pump.

22. A method for adjusting a distance between a suction liner and an impeller of a centrifugal pump, the method comprising:
causing at least one ultrasonic transducer to emit an ultrasonic pulse into the suction liner of the centrifugal pump, through a medium between the suction liner and the impeller of the centrifugal pump, and against the impeller of the centrifugal pump;
receiving, via a signal analyzer in communication with the at least one ultrasonic transducer, a first pulse return signal associated with an interface between the suction liner and the medium;
receiving, via the signal analyzer, a second pulse return signal associated with a surface of the impeller;
receiving, via the signal analyzer, one or more pulse reflection signals associated with reflections of the ultrasonic pulse between the suction liner and the impeller;
determining the distance between the suction liner and the impeller based at least in part on one or more of the first pulse return signal, the second pulse return signal, or the one or more pulse reflection signals; and
causing, based at least in part on the distance between the suction liner and the impeller, the suction liner to move axially in a direction substantially parallel to a shaft axis of a pump shaft coupled to the impeller.

23. The method of claim 22, wherein determining the distance between the suction liner and the impeller comprises determining one or more differences between one or more of the first pulse return signal, the second pulse return signal, or the one or more pulse reflection signals, and wherein determining the one or more differences comprises determining one or more time differences.

24. The method of claim 22, wherein causing the suction liner to move axially comprises rotating a plurality of adjustment bolts contacting a back surface of the suction liner opposite the impeller.

25. The method of claim 24, wherein rotating the plurality of adjustment bolts comprises activating a plurality of adjustment actuators coupled to the adjustment bolts to cause the adjustment bolts to move the suction liner axially.

26. The method of claim 25, further comprising:
receiving, via a suction liner controller in communication with the signal analyzer and the plurality of adjustment actuators, a gap signal indicative of the distance between the suction liner and the impeller; and
activating, via the suction liner controller, based at least in part on the gap signal, one or more of the plurality of adjustment actuators to cause the suction liner to move axially.

27. The method of claim 26, further comprising:
comparing, via the suction liner controller, the distance between the suction liner and the impeller to a range of distances between the suction liner and the impeller; and
when the distance between the suction liner and the impeller is outside the range of distances, activating one or more of the plurality of adjustment actuators to cause the suction liner to move axially such that the distance between the suction liner and the impeller is within the range of distances.
